(19) United States
(12) Patent Application Publication
(10) Pub. No.: US 2016/0379172 A1
(43) Pub. Date: Dec. 29, 2016

(54) METHOD AND DEVICE FOR CREATING EVENT REMINDER

(71) Applicant: Xiaomi Inc., Beijing (CN)

(72) Inventors: Hui SONG, Beijing (CN); Zhenhai ZHAO, Beijing (CN); Anting ZHAO, Beijing (CN)

(73) Assignee: Xiaomi Inc.

(21) Appl. No.: 15/191,875

(22) Filed: Jun. 24, 2016

(30) Foreign Application Priority Data
Jun. 26, 2015 (CN) 201510369427.3

(51) Int. Cl. G06Q 10/10; H04L 12/58

(52) U.S. Cl. CPC G06Q 10/1095; H04L 51/24

(57) ABSTRACT

The present disclosure relates to an event reminder method and an event reminder device, to create reminders automatically to remind users to early necessary articles. The method includes determining whether a received communication message includes an article-carrying notification. The method also includes obtaining information about an article to be carried from the article-carrying notification when determining that the received communication message includes the article-carrying notification. The method further includes creating an event reminder according to the information about the article to be carried.

### CROSS-REFERENCE TO RELATED APPLICATIONS

This application is based upon and claims priority to Chinese Patent Application No. 201510369427.3, filed on Jun. 26, 2015, the entire content of which is incorporated herein by reference.

### TECHNICAL FIELD

The present disclosure generally relates to the field of communication and more particularly, to methods and devices for creating event reminders.

### BACKGROUND

At present, with the development of communication technology, people usually convey to-do information to users by sending communication messages. For example, a railway service center, an airline service center, a museum service center, and other service centers may convey booking information to users by sending booking confirmation notification messages. Because the to-do information is usually sent to the users before the to-do events and/or tasks occur, the users may likely forget the to-do information. In order to facilitate processing of the to-do events and/or tasks, some users may choose to create reminders to remind themselves so they can remember the to-do information.

In the related art, an event reminder is manually created by a user. Specifically, the user may have to perform operations to enter an event reminder creation interface, where the user manually inputs the to-do information and sets related parameters. As a result, the entire process is based on manual operations, and is complicated. It results in waste of the user's time, inconvenience for the user to create event reminders, and a reduced user experience.

### SUMMARY

In order to solve the problems existing in the related art, the present disclosure provides an event reminder method and an event reminder device, so that an event reminder is created automatically to remind a user to carry necessary articles.

According to a first aspect of the present disclosure, there is provided a method for creating an event reminder. The method includes determining whether a received communication message includes an article-carrying notification. The method also includes obtaining information about an article to be carried from the article-carrying notification when determining that the received communication message includes the article-carrying notification. The method further includes creating an event reminder according to the information about the article to be carried.

According to a second aspect of the present disclosure, there is provided a device for creating an event reminder. The device includes a processor and a memory for storing instructions executable by the processor. The processor is configured to determine whether a received communication message includes an article-carrying notification. The processor is also configured to obtain information about an article to be carried from the article-carrying notification when determining that the received communication message includes the article-carrying notification. The processor is further configured to create an event reminder according to the information about the article to be carried.

According to a third aspect of the present disclosure, there is provided a non-transitory computer-readable storage medium. The non-transitory computer-readable storage medium is configured to store instructions therein that, when executed by a processor of a mobile terminal, cause the mobile terminal to perform a method for creating an event reminder. The method includes determining whether a received communication message includes an article-carrying notification. The method also includes obtaining information about an article to be carried from the article-carrying notification when determining that the received communication message includes the article-carrying notification. The method further includes creating an event reminder according to the information about the article to be carried.

It is to be understood that both the foregoing general description and the following detailed description are illustrative and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart showing a method for creating an event reminder according to an exemplary embodiment;

FIG. 2 is a flowchart showing a method for creating an event reminder according to another exemplary embodiment;

FIG. 3 is a flowchart showing a method for creating an event reminder according to another exemplary embodiment;

FIG. 4 is a flowchart showing a method for creating an event reminder according to another exemplary embodiment;

FIG. 5 is a flowchart showing a method for creating an event reminder according to another exemplary embodiment;

FIG. 6 is a flowchart showing a method for creating an event reminder according to another exemplary embodiment;

FIG. 7 is a flowchart showing a method for creating an event reminder according to another exemplary embodiment;

FIG. 8 is a flowchart showing a method for creating an event reminder according to another exemplary embodiment;

FIG. 9 is a block diagram showing a device for creating an event reminder according to an exemplary embodiment;

FIG. 10 is a block diagram showing a determining module included in a device for creating an event reminder according to an exemplary embodiment;

FIG. 11 is a block diagram showing a determining module included in a device for creating an event reminder according to another exemplary embodiment;

FIG. 12 is a block diagram showing a determining module included in a device for creating an event reminder according to another exemplary embodiment;

FIG. 13 is a block diagram showing a creating module included in a device for creating an event reminder according to an exemplary embodiment;

FIG. 14 is a block diagram showing a device for creating an event reminder according to another exemplary embodiment;

FIG. 15 is a block diagram showing a device for creating an event reminder according to another exemplary embodiment;

FIG. 16 is a block diagram showing a device for creating an event reminder according to another exemplary embodiment; and

FIG. 17 is a block diagram showing a device for creating an event reminder according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

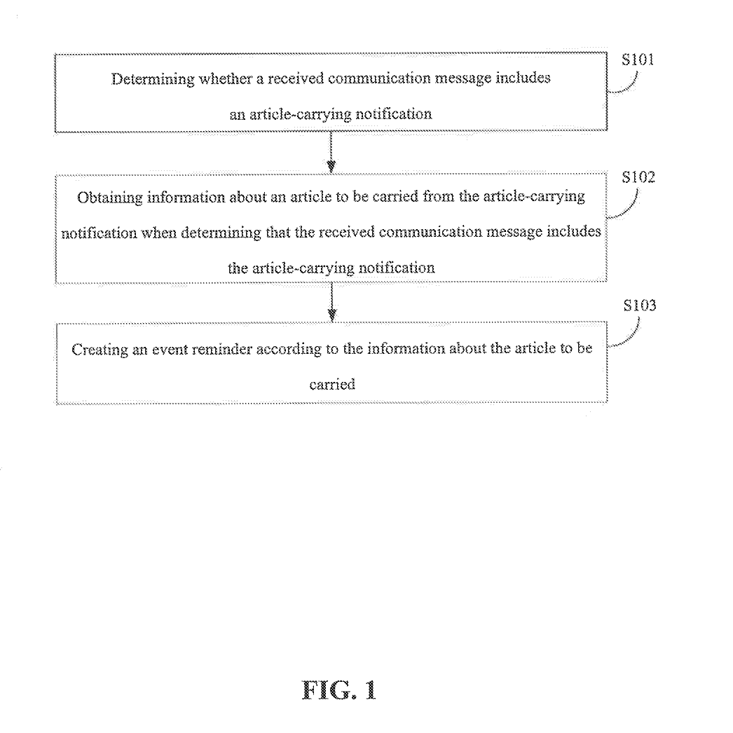

FIG. 1 is a flowchart showing a method for creating an event reminder according to an exemplary embodiment. The method shown in FIG. 1 may be performed by a terminal and includes the following steps.

In step S101, it is determined whether a received communication message includes an article-carrying notification.

In step S102, information about an article to be carried is obtained from the article-carrying notification when determining that the communication message includes the article-carrying notification.

In step S103, an event reminder is created according to the information about the article to be carried.

The technical solution according to the embodiments of the present disclosure has the following advantageous effects. With the disclosed technical solution, the information about the article to be carried is obtained from the article-carrying notification and the event reminder is created according to the information about the article to be carried. As a result, it is possible to create the event reminder automatically without relying on a manual operation, so as to remind a user to carry the article to be carried. The disclosed technical solution enables the user to handle a relevant event conveniently, simplifies the event reminder creation process, and improves the event reminder creation efficiency and user experience.

Each of the above steps will be discussed in detail below.

In an embodiment, the article mentioned in step S101 includes any one or more of a credential, a document, an apparatus, and clothing. For example, when the communication message received by a terminal of a user is a booking confirmation notification message that requires the user to carry an identity card when using a booked ticket, the article includes a credential, and the credential is the identity card.

In an embodiment, step S101 may be implemented in any one of the following methods according to different particular determination manners.

### First Method

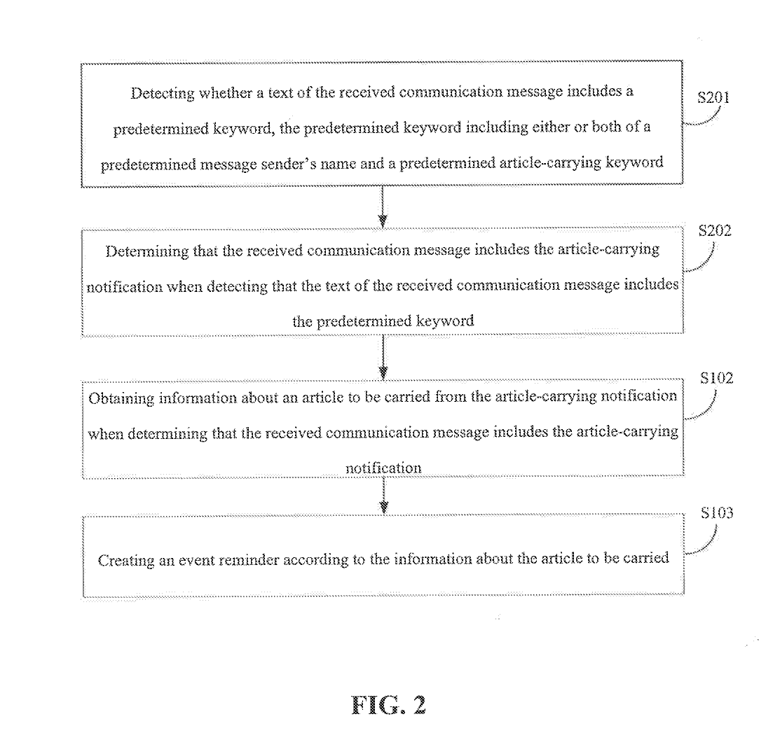

FIG. 2 is a flowchart showing a method for creating an event reminder according to another exemplary embodiment. As shown in FIG. 2, step S101 may be implemented as the following steps: S201 and S202. The method shown in FIG. 2 may be performed by a terminal.

In step S201, it is detected whether a text of the received communication message includes a predetermined keyword, the predetermined keyword including either or both of a name of a predetermined message sender and a predetermined article-carrying keyword.

In step S202, it is determined that the communication message includes the article-carrying notification when detecting that the text of the communication message includes the predetermined keyword.

In the above steps, the predetermined article-carrying keyword may include words relating to carrying XX credential, XX document, XX apparatus, XX clothing, or the like, since the content of the article-carrying notification typically includes one or more of these keywords. For example, when a meeting inviter sends a meeting invitation message to a user, the meeting invitation message typically indicates that the user is required to can a meeting invitation letter, a work permit, relevant documents, and other articles. After receiving the meeting invitation message, the terminal of the user may determine whether the meeting invitation message includes the article-carrying notification based on detection of one or more of the above article-carrying keywords (e.g., meeting invitation letter, work permit, relevant documents).

In the above steps, the name of the predetermined message sender may include a name of a railway service center, an airline service center, a museum service center, or other service suppliers. This is because these service suppliers typically send booking confirmation notification messages to a user after the user books tickets, to require the user to carry relevant credentials when using booked tickets. The content of the messages typically includes the name of the corresponding service supplier. For example, a railway server center typically sends a booking confirmation notification message to a user after the user books a railway ticket, to notify the user to carry an identity card when using the railway ticket. The content of the hooking confirmation notification message typically includes the name “railway service center,” in this example, the predetermined keyword may be set as the name “railway service center.” After receiving the communication message, the terminal of the user may detect whether the text of the communication message includes the predetermined keyword “railway service center.” When it is detected that the text of the communication message includes the predetermined keyword “railway service center,” it is determined that the communication message includes the booking confirmation notification.

With the above first method, it is determined whether the communication message includes the article-carrying notification by detecting whether the text of the communication message includes the predetermined keyword.

Alternative methods may be used. For example, the terminal may determine whether the communication message includes the article-carrying notification by detecting whether the text of the communication message includes a predetermined specified symbol or by detecting whether the text of the communication message includes the predetermined keyword and the predetermined specified symbol. For example, when sending an article-carrying notification by the sender, the sender typically inputs a specified symbol in the text of the communication message, such as “###” or “#carrying credential#.” In these examples, the terminal may determine whether the communication message includes the article-carrying notification by detecting whether the text of the communication message includes the specified symbol “#,” “###,” or a combination of the keyword and the specified symbol, such as “#carrying credential#.”

### Second Method

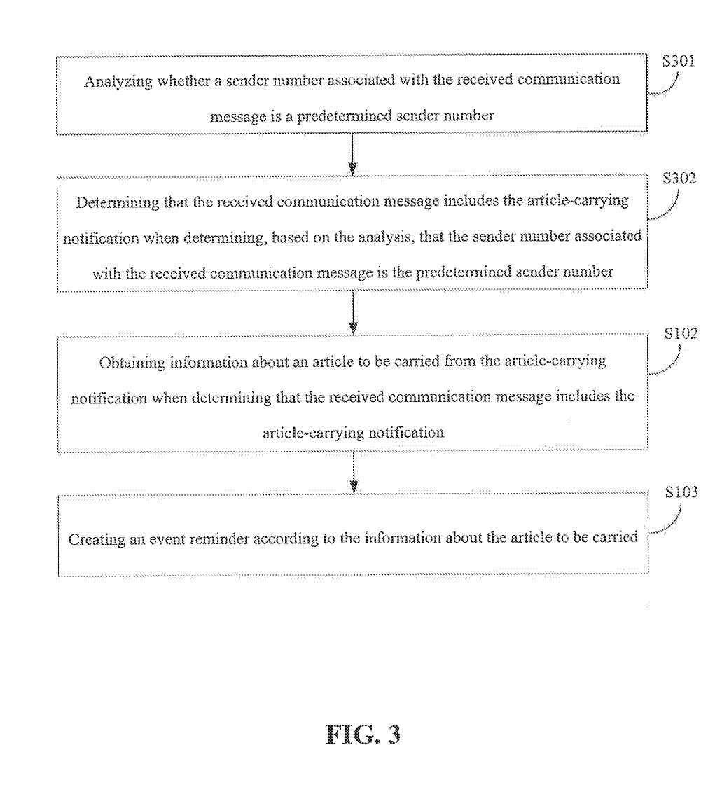

FIG. 3 is a flowchart showing a method for creating an event reminder according to another exemplary embodiment. As shown in FIG. 3, step S101 may be implemented as the following steps: S301 and S302. The method shown in FIG. 3 may be performed by a terminal.

In step S301, it is analyzed whether a sender number associated with the received communication message is a predetermined sender number.

In step S302, it is determined that the communication message includes the article-carrying notification when determining, based on the analysis, that the sender number associated with the communication message is the predetermined sender number.

For example, after a user books a railway ticket, a railway service center will typically send a booking confirmation notification message to the user to notify the user to carry an identity card when using the railway ticket, and a number (e.g., telephone number) associated with the railway service center sending the hooking confirmation notification message is “12306.” in this example, the predetermined sender number is set as “12306.” After the terminal of the user receives the communication message, it may be analyzed whether the sender number associated with the received communication message is “12306.” When it is analyzed that the sender number associated with the received communication message is “12306,” it is determined that the communication message includes the article-carrying notification.

With the above second method, it is determined whether the communication message includes the article-carrying notification by analyzing whether the sender number associated with the communication message is the predetermined sender number.

### Third Method

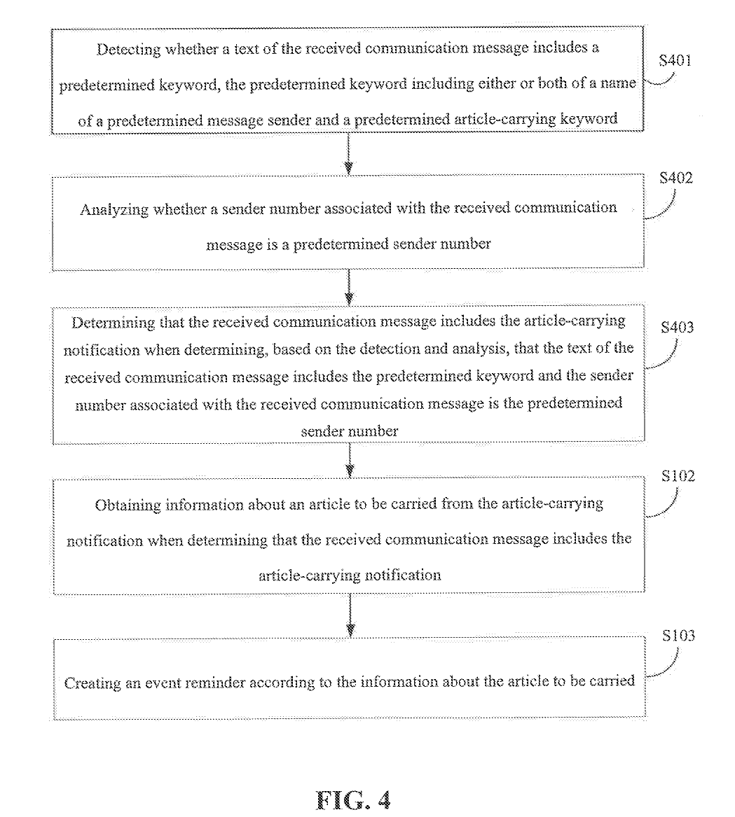

FIG. 4 is a flowchart showing a method for creating an event reminder according to another exemplary embodiment. As shown in FIG. 4, step S101 may also be implemented as the following steps: S401 to S403. The method shown in FIG. 4 may be performed by a terminal.

In step S401, it is detected whether a text of the received communication message includes a predetermined keyword, the predetermined keyword including either or both of a name of a predetermined message sender and a predetermined article-carrying keyword.

In step S402, it is analyzed whether a sender number associated with the communication message is a predetermined sender number.

In step S403, it is determined that the communication message includes the article-carrying notification when determining, based on the detection and analysis, that the text of the communication message includes the predetermined keyword and the sender number associated with the communication message is the predetermined sender number.

The third method combines the detection and analysis included in the first method and the second method to further improve accuracy of determining that the communication message includes the article-carrying notification.

With the third method, it is determined whether the communication message includes the article-carrying notification by detecting the text of the communication message and analyzing the sender number associated with the communication message. Thus, the article-carrying notification can be identified more accurately.

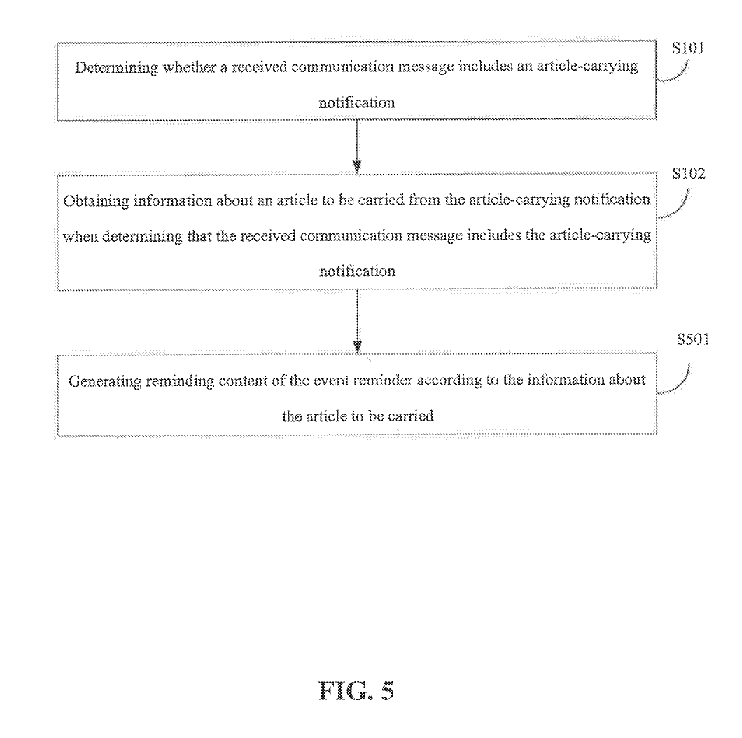

FIG. 5 is a flowchart showing a method for creating an event reminder according to another exemplary embodiment. As shown in FIG. 5, step S103 may be implemented as step S501.

In step S501, reminding content of the event reminder is generated according to the information about the article to be carried, thereby automatically recording the information about the article to be carried in the reminding content of the event reminder, so as to remind the user to carry the article to be carried. A reminding time of the event reminder may be set to provide the user an event reminder, after the article-carrying notification is received, once every preset time interval.

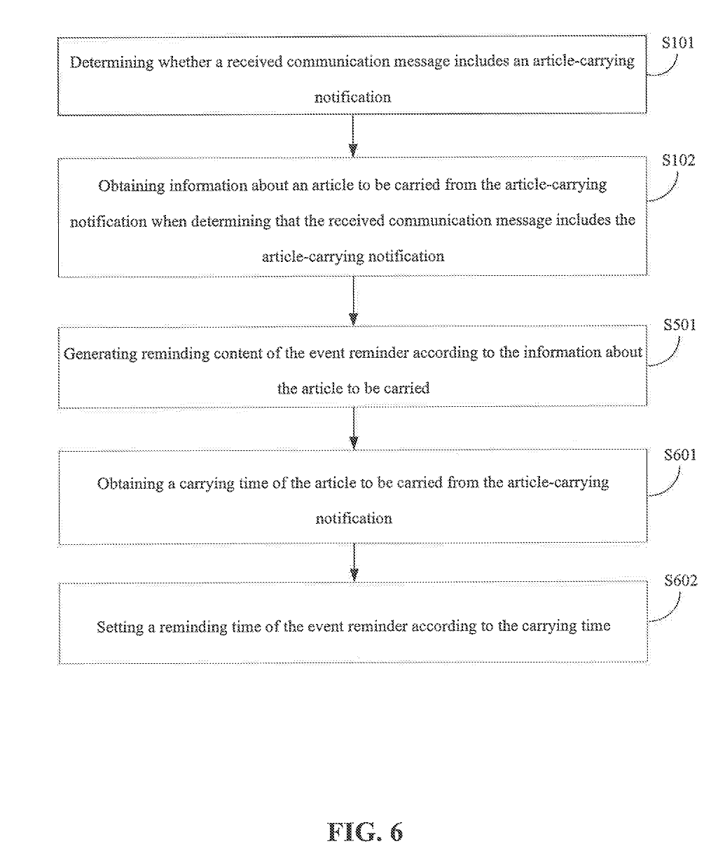

In addition to the above steps shown in FIG. 5, in some embodiments, as shown in FIG. 6, the method may further include the following steps: S601 and S602. FIG. 6 is a flowchart showing a method for creating an event reminder according to another exemplary embodiment. The method shown in FIG. 6 may be performed by a terminal.

In step S601, a carrying time of the article to be carried is obtained from the article-carrying notification.

In step S602, a reminding time of the event reminder is set according to the carrying time.

For example, if a boarding time included in the railway ticket obtained from a booking confirmation notification message (e.g., a short message) is 8:00 a.m. on May 1, 2015, the reminding time of the event reminder may be set to be 12 hours before the boarding time, i.e., the reminding time may be set to be 8:00 p.m. on Apr. 30, 2015.

With these steps, the reminding time of the event reminder is automatically set according to the carrying time of the article to be carried, so as to remind the user to carry the article to be carried before the carrying time is reached.

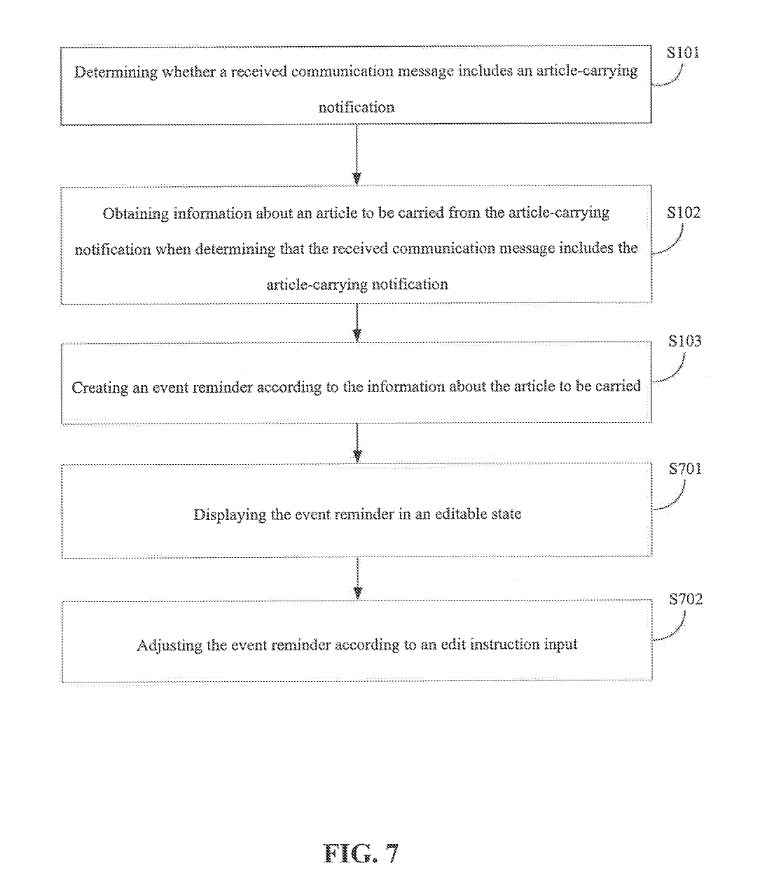

FIG. 7 is a flowchart showing a method for creating an event reminder according to another exemplary embodiment. As shown in FIG. 7, the method may further include the following steps: S701 and S702. The method shown in FIG. 7 may be performed by a terminal.

In step S701, the event reminder is displayed in an editable state.

In step S702, the event reminder is adjusted according to an edit instruction input.

The event reminder is automatically generated according to the above method after the article-carrying notification is received. However, for reminders of different article-carrying notifications, the user may have different requirements for the reminding time, the reminding content, etc. Thus, it is desirable to provide the user an opportunity to adjust the event reminder according to his/her own needs before the event reminder is saved, such that the event reminder better meets the needs of the user.

With these steps, the event reminder is adjusted according to the needs of the user after the event reminder is automatically created, such that the event reminder meets the individual needs of the user.

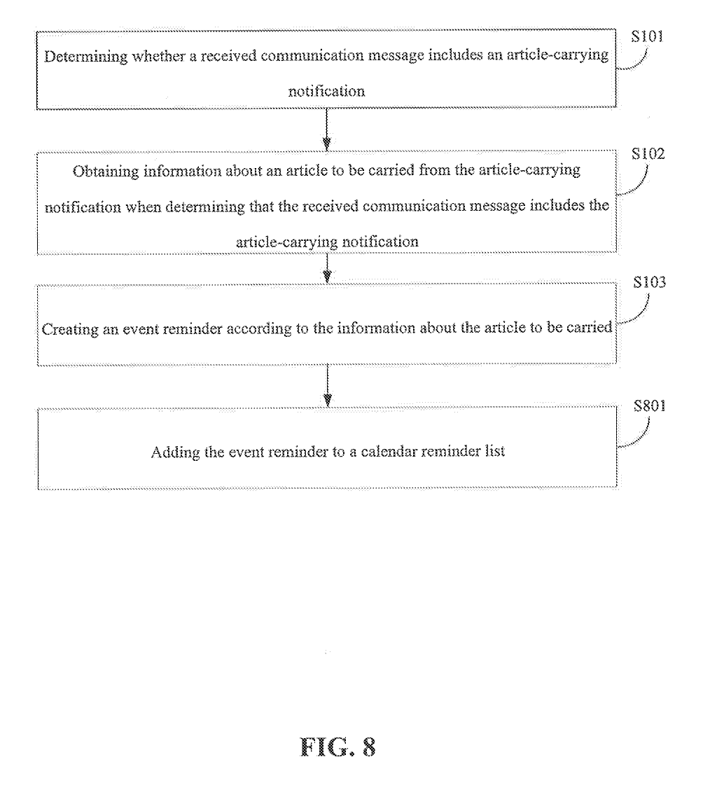

FIG. 8 is a flowchart showing a method for creating an event reminder according to another exemplary embodiment. As shown in FIG. 8, the method may further include step S801. The method shown in FIG. 8 may be performed by a terminal.

In step S801, the event reminder is added to a calendar reminder list.

With these step, the event reminder is realized using the reminding function of a calendar application, such that the user may arrange affairs indicated by the event reminder.

In an embodiment, the article-carrying, notification may include a booking confirmation notification message (e.g., a short message), and the article to be carried may include an identity card. In sonic embodiments, the steps in the present disclosure may be implemented by a short message application (APP) included in the terminal. For example, a railway service center sends a booking confirmation notification short message to the user. The terminal of the user receives the booking confirmation notification short message and determines whether the booking confirmation notification short message includes the article-carrying notification. When it is determined that the booking confirmation notification short message includes the article-carrying notification, information about the article to be carried when using a ticket and a ticket time are obtained from the booking confirmation notification short message. The article to be carried includes an identity card. In some embodiments, a calendar reminder is created, and the reminding content of the calendar reminder is edited so as to remind a user to carry the identity card. The reminding time of the calendar reminder may be set to be 12 hours before the ticket time. The calendar reminder is displayed in an editable state, and is adjusted according to an edit instruction input. The calendar reminder is added to a calendar reminder list.

In an embodiment, in addition to the form of a short message, the communication message may also be in a form of an email message or the like. The present disclosure does not limit the form of the communication message.

With the above steps, the event reminder is created automatically without relying on a manual operation, so as to remind the user to carry the article to be carried when using the ticket. The disclosed methods enable the user to use the booked ticket conveniently, simplify the event reminder creation process, and improve the creation efficiency and user experience.

Based on the same inventive concept, the present disclosure also provides a device for creating an event reminder. Since the device solves the problem through a principle similar to that of the disclosed methods for creating the event reminder, the detailed operations performed by the device may be understood by referring to the above discussions of the embodiments of the disclosed methods. Thus, the detailed operations of the device are not repeated.

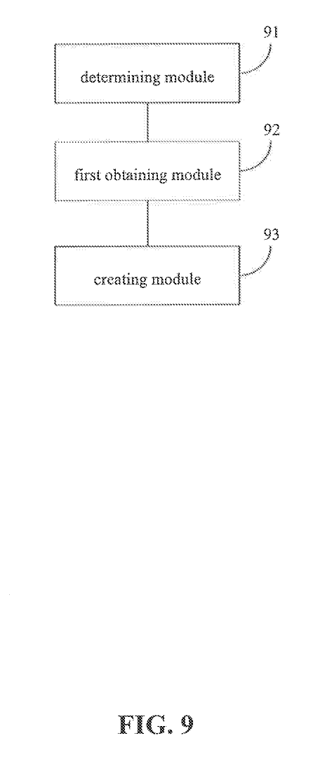

FIG. 9 is a block diagram showing a device for creating an event reminder according to an exemplary embodiment. As shown in FIG. 9, the device includes a determining module 91 configured to determine whether a received communication message includes an article-carrying notification. The device also includes a first obtaining module 92 configured to obtain information about an article to be carried, from the article-carrying notification, when the determining module 91 determines that the communication message includes the article-carrying notification. The device further includes a creating module 93 configured to create an event reminder according to the information about the article to be carried.

The technical solution according to the embodiments of the present disclosure has the following advantageous effects. With the disclosed technical solution, the information about the article to be carried is obtained from the article-carrying notification and the event reminder is created according to the information about the article to be carried. It is possible to create the event reminder automatically without relying on a manual operation, so as to remind a user to carry the article to be carried. The disclosed technical solution enables the user to handle a relevant event conveniently, simplifies the event reminder creation process, and improves the event reminder creation efficiency and user experience.

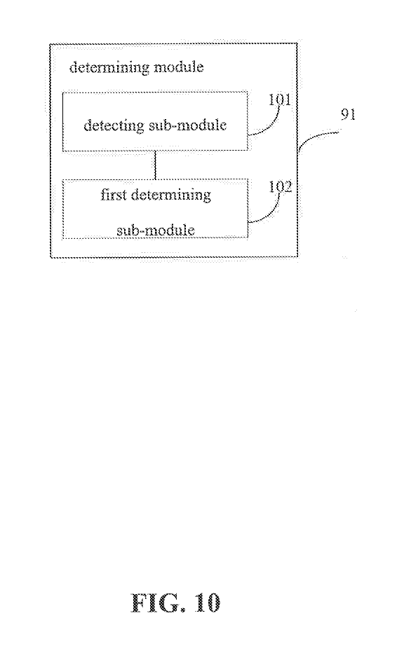

FIG. 10 is a block diagram showing a determining module included in a device for creating an event reminder according to an exemplary embodiment. As shown in FIG. 10, the determining module 91 includes a detecting sub-module 101 configured to detect whether a text of the received communication message includes a predetermined keyword, the predetermined keyword including either or both of a name of a predetermined message sender and a predetermined article-carrying keyword. The determining module 91 also includes a first determining sub-module 102 configured to determine that the communication message includes the article-carrying notification when the detecting sub-module 101 detects that the text of the communication message includes the predetermined keyword.

In this embodiment, it is determined whether the communication message includes the article-carrying notification by detecting whether the text of the communication message includes the predetermined keyword.

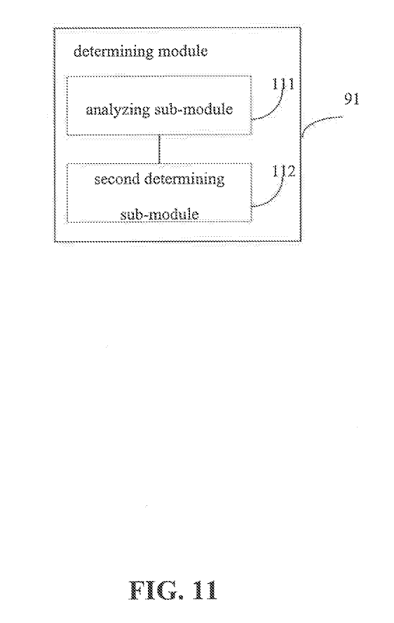

FIG. 11 is another block diagram showing a determining module included in a device for creating an event reminder according to another exemplary embodiment. As shown in FIG. 11, the determining module 91 includes an analyzing sub-module 111 configured to analyze whether a sender number associated with the received communication message is a predetermined sender number. The determining module 91 also includes a second determining sub-module 112 configured to determine that the communication message includes the article-carrying notification when it is determined, based on the analysis performed by the analyzing sub-module 111, that the sender number associated with the communication message is the predetermined sender number.

In this embodiment, it is determined whether the communication message includes the article-carrying notification by determining whether the sender number associated with the communication message is the predetermined sender number.

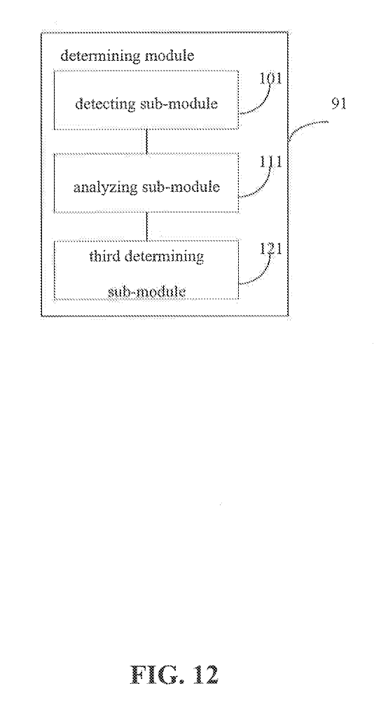

FIG. 12 is a block diagram showing a determining module included in a device for creating an event reminder according to another exemplary embodiment. As shown in FIG. 12, the determining module 91 includes the detecting sub-module 101 configured to detect whether a text of the received communication message includes a predetermined keyword, the predetermined keyword including either or both of a name of a predetermined message sender and a predetermined article-carrying keyword. The determining module 91 also includes the analyzing sub-module 111 configured to analyze whether a sender number associated with the received communication message is a predetermined sender number. The determining module 91 further includes a third determining sub-module 121 configured to determine that the communication message includes the article-carrying notification when it is determined, based on the detection and analysis, that the text of the communication message includes the predetermined keyword and the sender number associated with the communication message is the predetermined sender number.

In this embodiment, it is determined whether the communication message includes the article-carrying notification by detecting the text of the communication message and analyzing the sender number associated with the communication message, thereby more accurately identifying the article-carrying notification.

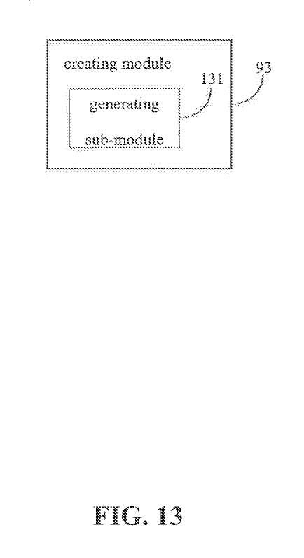

FIG. 13 is a block diagram showing a creating module included in a device for creating an event reminder according to an exemplary embodiment. As shown in FIG. 13, the creating module 93 includes a generating sub-module 131 configured to generate reminding content of the event reminder according to the information about the article to be carried.

In this embodiment, the information about the article to be carried is automatically recorded in the reminding content of the event reminder, so as to remind the user to carry the article to be carried.

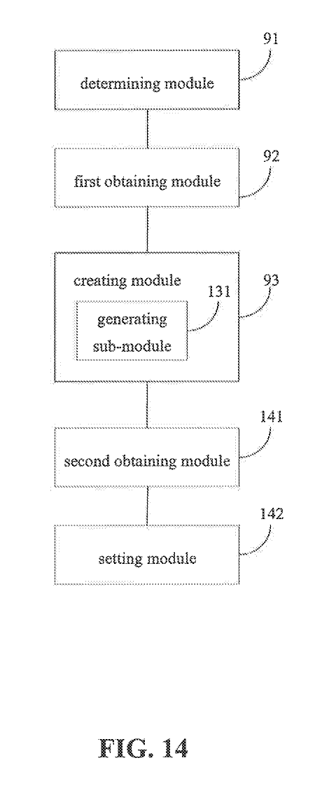

FIG. 14 is a block diagram showing a device for creating an event reminder according to another exemplary embodiment. As shown in FIG. 14, the device also includes a second obtaining module 141 configured to obtain a carrying time of the article to be carried from the article-carrying notification. The device further includes a setting module 142 configured to set a reminding time of the event reminder according to the carrying time.

In this embodiment, the reminding time of the event reminder is automatically set according to the carrying time of the article to be carried, so as to remind the user to carry the article to be carried before the carrying time.

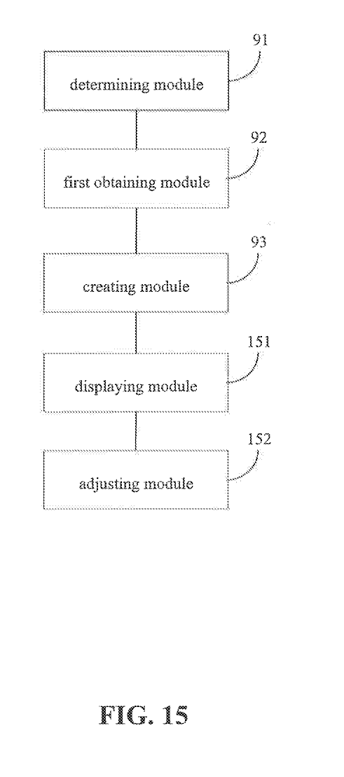

FIG. 15 is a block diagram showing a device for creating an event reminder according to another exemplary embodiment. As shown in FIG. 15, the device also includes a displaying module 151 configured to display the event reminder in an editable state. The device farther includes an adjusting module 152 configured to adjust the event reminder according to an edit instruction input.

In this embodiment, the event reminder is adjusted according to the needs of the user after the event reminder is automatically created, such that the event reminder meets the individual needs of the user.

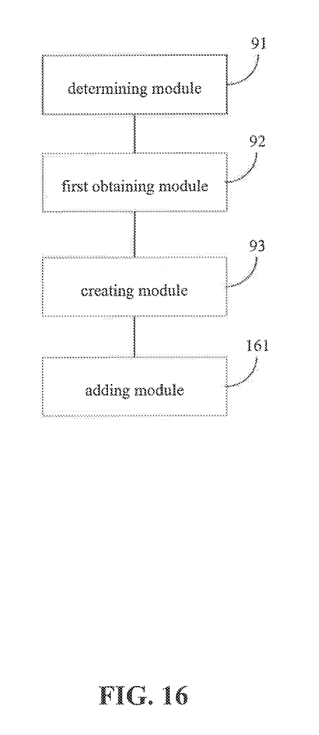

FIG. 16 is a block diagram showing a device for creating an event reminder according to another exemplary embodiment. As shown in FIG. 16, the device further includes an adding module 161 configured to add the event reminder to a calendar reminder list.

In this embodiment, the event reminder is realized by using the reminding function of a calendar application, such that the user may arrange affairs indicated by the event reminder.

In an embodiment, the present disclosure also provides a device for creating an event reminder. The device includes a processor and a memory for storing instructions executable by the processor. The processor is configured to execute the instructions to determine whether a received communication message includes an article carrying notification. The processor is also configured to execute the instructions to obtain information about an article to be carried from the article-carrying notification when determining that the communication message includes the article-carrying notification. The processor is further configured to execute the instructions to create an event reminder according to the information about the article to be carried.

The technical solution according to the embodiments of the present disclosure has the following advantageous effects. With the disclosed technical solution, the information about the article to be carried is obtained from the article-carrying notification and the event reminder is created according to the information about the article to be carried. It is possible to create the event reminder automatically without relying on a manual operation, so as to remind a user to carry the article to be carried. The disclosed technical solution enables the user to handle a relevant event conveniently, simplifies the event reminder creation process, and improves the event reminder creation efficiency and user experience.

With respect to the disclosed devices, the specific operations performed by various disclosed modules have been described in detail in the discussions of the embodiments of the disclosed methods. Therefore, the descriptions for the specific operations are not repeated.

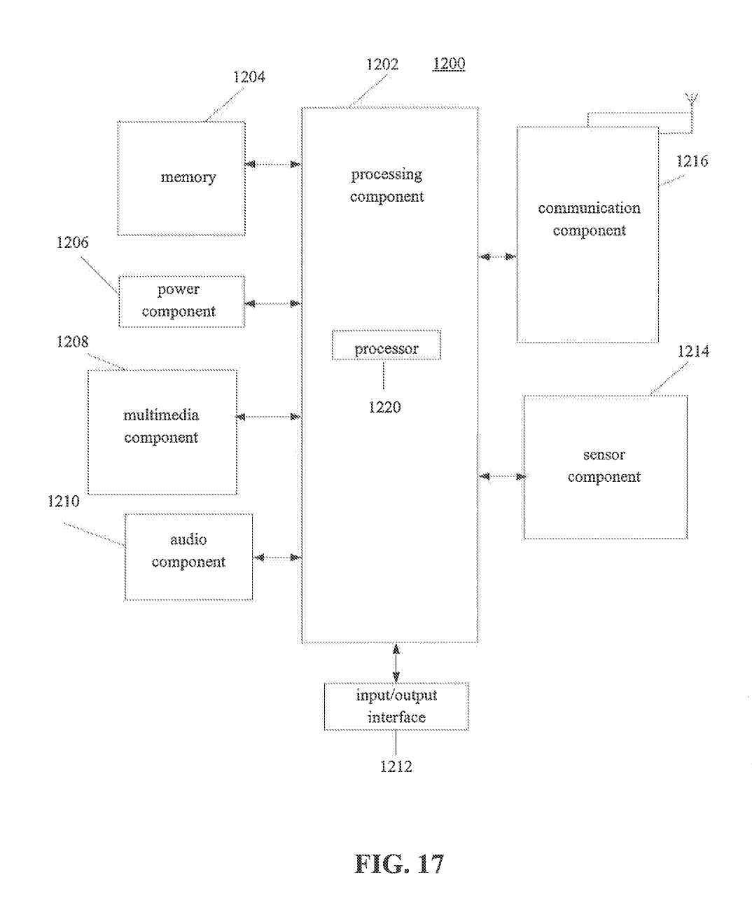

FIG. 17 is a block diagram showing a device 1200 for creating an event reminder according to an exemplary embodiment. The device may be implemented as a terminal. For example, the device 1200 (and the terminal) may be a mobile phone, a computer, a digital broadcast terminal, a message receiving and sending device, a gaming console, a tablet device, a medical device, exercise equipment, a personal digital assistant, and the like.

Referring to FIG. 17, the device 1200 includes one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 is configured to control overall operations of the device 1200, such as the operations associated with display, telephone calls, data communications, camera operations, and recording operations. The processing component 1202 includes one or more processors 1220 configured to execute instructions to perform all or part of the above described methods. The processing component 1202 may include one or more modules configured to facilitate the interaction between the processing component 1202 and other components. For instance, the processing component 1202 may include a multimedia module configured to facilitate the interaction between the multimedia component 1208 and the processing component 1202.

The memory 1204 is configured to store various types of data to support the operation of the device 1200. Examples of such data include instructions for any applications or methods implemented in or performed by the device 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

The power component 1206 is configured to provide power to various components of the device 1200. The power component 1206 may include a power management system, one or more power sources, and any other components associated with the generation, management, and distribution of power in the device 1200.

The multimedia component 1208 includes as screen providing an output interface between the device 1200 and the user, In some embodiments, the screen may include a liquid crystal display and a touch panel. If the screen includes the touch panel, the screen may be implemented as a touch screen configured to receive input signals from the user. The touch panel includes one or more touch sensors configured to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and/or the rear camera may receive an external multimedia datum while the device 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone configured to receive an external audio signal when the device 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker configured to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors configured to provide status assessments of various aspects of the device 1200. For instance, the sensor component 1214 may detect at least one of the following: an open/closed status of the device 1200, relative positioning of components, e.g., the display and the keypad, of the device 1200, a change in position of the device 1200 or a component of the device 1200, a presence or absence of user contact with the device 1200, an orientation or an acceleration/deceleration of the device 1200, and a change in temperature of the device 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate wired or wireless communication between the device 1200 and other devices. The device 1200 can access a wireless network based on a communication standard, such as WiFi, 2G or 3G, or a combination thereof. In an exemplary embodiment, the communication component 1216 receives a broadcast signal or broadcast associated information from an external broadcast management system via a broadcast channel. In an exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1204, executable by the processor 1220 included in the device 1200, for performing the above-described methods. For example, the non-transitory computer-readable storage medium may be a ROM, a RAM, a CD-ROM, a magnetic tape, a floppy disc, an optical data storage device, and the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for creating an event reminder, comprising:
determining whether a received communication message includes an article-carrying notification;
obtaining information about an article to be carried from the article-carrying notification when determining that the received communication message includes the article-carrying notification; and
creating an event reminder according to the information about the article to be carried.

2. The method of claim 1, wherein determining whether the received communication message includes the article-carrying notification comprises:
detecting whether a text of the received communication message includes a predetermined keyword, the predetermined keyword including either or both of a name of a predetermined message sender and a predetermined article-carrying keyword; and
determining that the received communication message includes the article-carrying notification when detecting that the text of the received communication message includes the predetermined keyword.

3. The method of claim 1, wherein determining whether the received communication message includes the article-carrying notification comprises:
analyzing whether a sender number associated with the received communication message is a predetermined sender number; and
determining that the received communication message includes the article-carrying notification when determining, based on the analysis, that the sender number associated with the received communication message is the predetermined sender number.

4. The method of claim 1, wherein determining whether the received communication message includes the article-carrying notification comprises:
detecting whether a text of the received communication message includes a predetermined keyword, the predetermined keyword including either or both of a name of a predetermined message sender and a predetermined article-carrying keyword;
analyzing whether a sender number associated with the received communication message is a predetermined sender number; and
determining that the received communication message includes the article-carrying notification when determining, based on the detection and analysis, that the text of the received communication message includes the predetermined keyword and the sender number associated with the received communication message is the predetermined sender number.

5. The method of claim 1, wherein creating the event reminder according to the information about the article to be carried comprises:
generating reminding content of the event reminder according to the information about the article to be carried.

6. The method of claim 1, further comprising:
obtaining a carrying time of the article to be carried from the article-carrying notification; and
setting a reminding time of the event reminder according to the carrying time.

7. The method of claim 2, further comprising:
obtaining a carrying time of the article to be carried from the article-carrying notification; and
setting a reminding time of the event reminder according to the carrying time.

8. The method of claim 3, further comprising:
obtaining a carrying time of the article to be carried from the article-carrying notification; and
setting a reminding time of the event reminder according to the carrying time.

9. The method of claim 4, further comprising:
obtaining a carrying time of the article to be carried from the article-carrying notification; and
setting a reminding time of the event reminder according to the carrying time.

10. The method of claim 5, further comprising:
obtaining a carrying time of the article to be carried from the article-carrying notification; and
setting a reminding time of the event reminder according to the carrying time.

11. The method of claim 1, further comprising:
displaying the event reminder in an editable state; and
adjusting the event reminder according to an edit instruction input.

12. The method of claim 1, further comprising:
adding the event reminder to a calendar reminder list.

13. A device for creating an event reminder, comprising:
a processor; and
a memory for storing instructions executable by the processor,
wherein the processor is configured to:
determine whether a received communication message includes an article-carrying notification;
obtain information about an article to he carried from the article-carrying notification when determining that the received communication message includes the article-carrying notification; and
create an event reminder according to the information about the article to be carried.

14. The device of claim 13, wherein the processor is configured to determine whether the received communication message includes the article-carrying notification by:
detecting whether a text of the received communication message includes a predetermined keyword, the predetermined keyword including either or both of a name of a predetermined message sender and a predetermined article-carrying keyword; and
determining that the received communication message includes the article-carrying notification when detecting that the text of the received communication message includes the predetermined keyword.

15. The device of claim 13, wherein the processor is configured to determine whether the received communication message includes the article-carrying notification by:
analyzing whether a sender number associated with the received communication message received is a predetermined sender number; and
determining that the received communication message includes the article-carrying notification when determining, based on the analysis, that the sender number associated with the received communication message is the predetermined sender number.

16. The device of claim 13, wherein the processor determines whether the received communication message includes the article-carrying notification by:
detecting whether a text of the received communication message includes a predetermined keyword, the predetermined keyword including either or both of a name of a predetermined message sender and a predetermined article-carrying keyword;
analyzing whether a sender number associated with the received communication message is a predetermined sender number; and
determining that the received communication message includes the article-carrying notification when determining, based on the detection and analysis, that the text of the received communication message includes the predetermined keyword and the sender number associated with the received communication message is the predetermined sender number.

17. The device of claim 13, wherein the processor is further configured to:
obtain a carrying time of the article to be carried from the article-carrying notification; and
set a reminding time of the event reminder according to the carrying time.

18. The device of claim 13, wherein the processor is further configured to
display the event reminder in an editable state; and
adjust the event reminder according to an edit instruction input.

19. The device of claim 13, wherein the processor is further configured to add the event reminder to a calendar reminder list.

20. A non-transitory computer-readable storage medium having stored therein instructions that, when executed by a processor of a mobile terminal, cause the mobile terminal to perform a method for creating an event reminder, the method comprising:
determining whether a received communication message includes an article-carrying notification;
obtaining information about an article to be carried from the article-carrying notification when determining that the received communication message includes the article-carrying notification; and
creating an event reminder according to the information about the article to be carried.
